(19) United States
(12) Patent Application Publication
(10) Pub. No.: US 2014/0185290 A1
(43) Pub. Date: Jul. 3, 2014

(54) VARIABLE BEAM ANGLE ILLUMINATION

(71) Applicant: LUMINUS DEVICES, INC., Billerica, MA (US)

(72) Inventors: Donald L. McDaniel, JR., North Andover, MA (US); Andrei Kazmierski, Acton, MA (US)

(73) Assignee: Luminus Devices, Inc., Billerica, MA (US)

(21) Appl. No.: 13/728,169

(22) Filed: Dec. 27, 2012

(51) Int. Cl. F21V 5/00

(52) U.S. Cl. CPC F21V 5/007
USPC 362/244; 362/235

(57) ABSTRACT

Light-emitting diodes, and related components, processes, systems, and methods are generally described.

### TECHNICAL FIELD

Light-emitting diodes, and related components, processes, systems, and methods are generally described.

### BACKGROUND

A light-emitting diode (LED) often can provide light in a more efficient manner than an incandescent light source and/or a fluorescent light source.

Typically, an LED is formed of multiple layers, with at least some of the layers being formed of different materials. In general, the materials and thicknesses selected for the layers determine the wavelength(s) of light emitted by the LED. In addition, the chemical composition of the layers can be selected to try to isolate injected electrical charge carriers into regions (commonly referred to as quantum wells) for relatively efficient conversion to optical power. Generally, the layers on one side of the junction where a quantum well is grown are doped with donor atoms that result in high electron concentration (such layers are commonly referred to as n-type layers), and the layers on the opposite side are doped with acceptor atoms that result in a relatively high hole concentration (such layers are commonly referred to as p-type layers).

A common approach to preparing an LED is as follows. The layers of material are prepared in the form of a wafer. Typically, the layers are formed using an epitaxial deposition technique, such as metal-organic chemical vapor deposition (MOCVD), with the initially deposited layer being formed on a growth substrate. The layers are then exposed to various etching and metallization techniques to form contacts for electrical current injection, and the wafer is subsequently sectioned into individual LED chips. Usually, the LED chips are packaged.

During use, electrical energy is usually injected into an LED and then converted into electromagnetic radiation (light), some of which is extracted from the LED, for example, via an emission surface.

The relatively high power efficiency associated with LEDs has created an interest in using LEDs to displace conventional light sources in a variety of lighting applications. For example, in some instances LEDs are being used as traffic lights and to illuminate cell phone keypads and displays. LEDs can also be used in many other traditional lighting applications, including spot lighting applications. Improved systems and methods for using LEDs in such applications would be desirable.

### SUMMARY

Light-emitting diodes, and related components, processes, systems, and methods are generally described. The subject matter of the present invention involves, in some cases, interrelated products, alternative solutions to a particular problem, and/or a plurality of different uses of one or more systems and/or articles.

In one aspect, a system comprising an array of light-emitting diodes is described. In certain embodiments, the system comprises an array of light-emitting diodes having non-rectangular emission areas, the array of light-emitting diodes defining an outer perimeter having an approximately circular configuration, and an array of collimating lenses. In some such embodiments, the collimating lenses are configured to receive light emitted from the light-emitting diodes and redirect at least a portion of the light received from the light-emitting diodes toward an intersection plane such that the re-directed light from each of the collimating lenses overlaps at the intersection plane.

In some embodiments, the system comprises an array of light-emitting diodes, comprising a first light-emitting diode having a non-rectangular emission area, a second light-emitting diode having a non-rectangular emission area, and a third light-emitting diode having a non-rectangular emission area. The system further comprises, in certain embodiments, an array of collimating lenses comprising a first collimating lens configured to receive at least a portion of the light emitted by the first light-emitting diode, a second collimating lens configured to receive at least a portion of the light emitted by the second light-emitting diode, and a third collimating lens configured to receive at least a portion of the light emitted by the third light-emitting diode. In some such embodiments, the collimating lenses are configured to re-direct at least a portion of the light received from the light-emitting diodes toward an intersection plane such that the re-directed light from each of the collimating lenses overlaps at the intersection plane.

In another aspect, a method of producing a substantially circular-shaped, far-field illumination is provided. The method comprises, in some embodiments, emitting light from an array of light-emitting diodes comprising non-rectangular emission areas toward an array of collimating lenses. In some such embodiments, at least a portion of the light emitted from the light-emitting diodes is re-directed by the collimating lenses toward an intersection plane, and the re-directed light overlaps at the intersection plane.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1D are schematic illustrations of optical systems, according to certain embodiments;

FIGS. 2A-2E are schematic illustrations of emission areas, according to certain embodiments;

FIG. 2F is a schematic illustration of a system in which a relatively narrow beam angle is produced, according to some embodiments;

FIG. 2G is a schematic illustration, according to certain embodiments, of a system in which a relatively wide beam angle is produced;

FIGS. 3A-3C are, according to some embodiments, schematic illustrations of light emitting diodes and images at the intersection plane;

FIG. 4 illustrates a light-emitting diode according to one set of embodiments;

FIG. 5 is a schematic illustration of an array of light-emitting diodes, according to some embodiments;

FIG. 6 is a schematic illustration of an optical system, according to one set of embodiments;

FIGS. 7A-7C illustrate arrays of light-emitting diodes, according to certain embodiments; and

FIGS. 8A-8H illustrate images at an intersection plane and at far-field, according to certain embodiments.

### DETAILED DESCRIPTION

Light-emitting diodes, and related components, processes, systems, and methods are generally described. In some embodiments, an optical system containing light-emitting diodes and collimating lenses is used to produce illumination on a surface. The light-emitting diodes and collimating lenses can be configured, in certain embodiments, the produce non-rectangular emission shapes, such as substantially circular emission shapes.

Many illumination applications require an approximately circular shaped illumination at a far-field surface. As one example, circular spot lights are frequently used to provide targeted illumination for stage productions. To achieve circular-shaped far-field illumination, many optical systems utilize projectors with a circular input aperture. Exemplary optical systems of this type may include a source that projects light through a circular aperture prior to the light reaching the object that is to be illuminated. For systems using rectangular light-emitting diodes, the circular aperture is over-filled with light from the light-emitting diodes. Though these systems can produce circular illumination at far-field locations, some of the light collected from the source is not able to pass through the aperture, resulting in reduced system efficiency.

It has been discovered, within the context of certain embodiments of the present invention, that one can produce a high efficiency system in which an approximately circular far-field illumination is produced without an aperture by using an array of light-emitting diodes (e.g., including three or more LEDs) having non-rectangular emission areas. The use of such non-rectangular emission areas can lead to enhancements in overall system efficiency when the emissions from the non-rectangular emission areas are overlapped, for example, to form a non-rectangular spot. In some embodiments, variable beam angle illumination and image space telecentricity can also be achieved with high system efficiency.

In certain embodiments, the light-emitting diodes may be arranged in an array that has an outer perimeter with defined shape. For example, the light-emitting diodes may be arranged in an array that has a substantially circular shape (i.e., the outer perimeter of the array of light-emitting diodes may be approximately circular).

In some embodiments, collimating lenses may be positioned to receive electromagnetic radiation emitted from the light-emitting diodes, for example, in the form of an array of collimating lenses. In certain embodiments, the collimating lenses redirect the electromagnetic radiation emitted from the light-emitting diodes toward an intersection plane, where the electromagnetic radiation from the light-emitting diodes overlaps. Electromagnetic radiation that passes through the intersection plane may, in certain embodiments, undergo further manipulation, for example, to produce an approximately circular illumination (e.g., in the form of an approximately circular beam of electromagnetic radiation) at a far-field location (e.g., a far-field surface). The respective characteristics and configuration of the components of the optical system may be selected to impart desirable properties including enhanced optical efficiency, amongst other benefits. Optical systems of the present invention may be particularly well suited for applications that involve far-field illumination, such as spot lights, though the system may also be used in other applications.

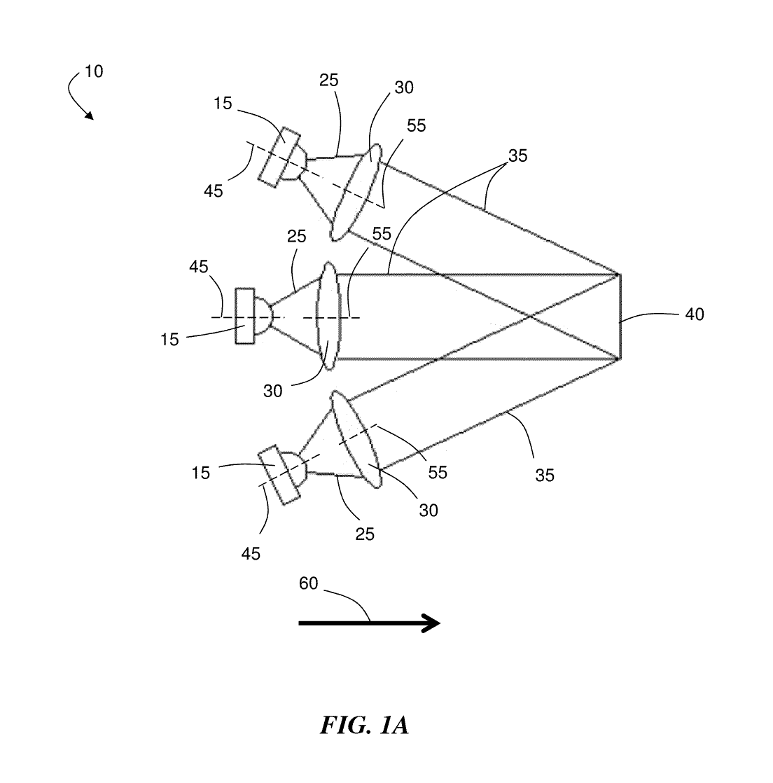

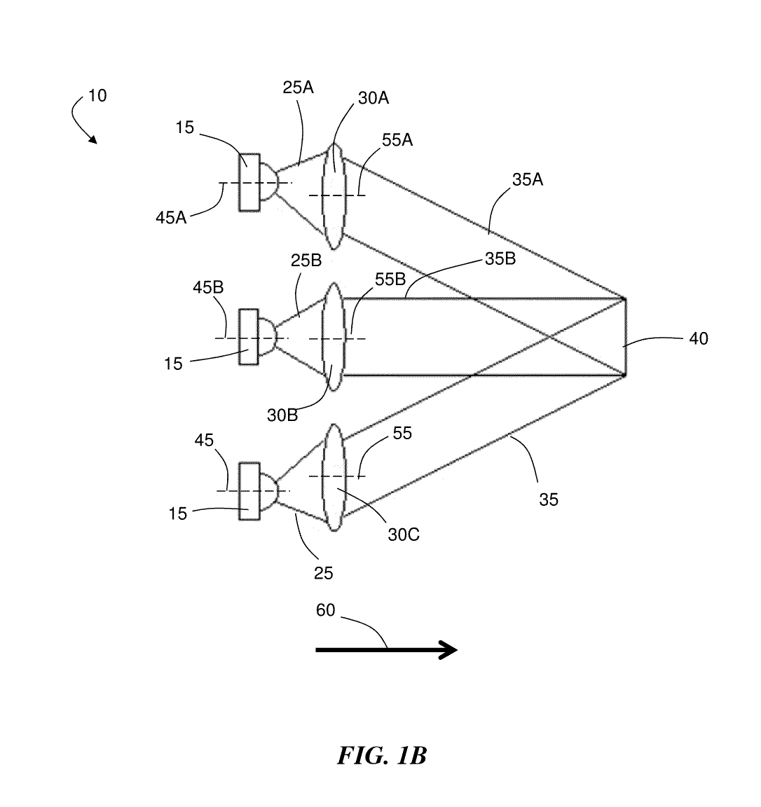

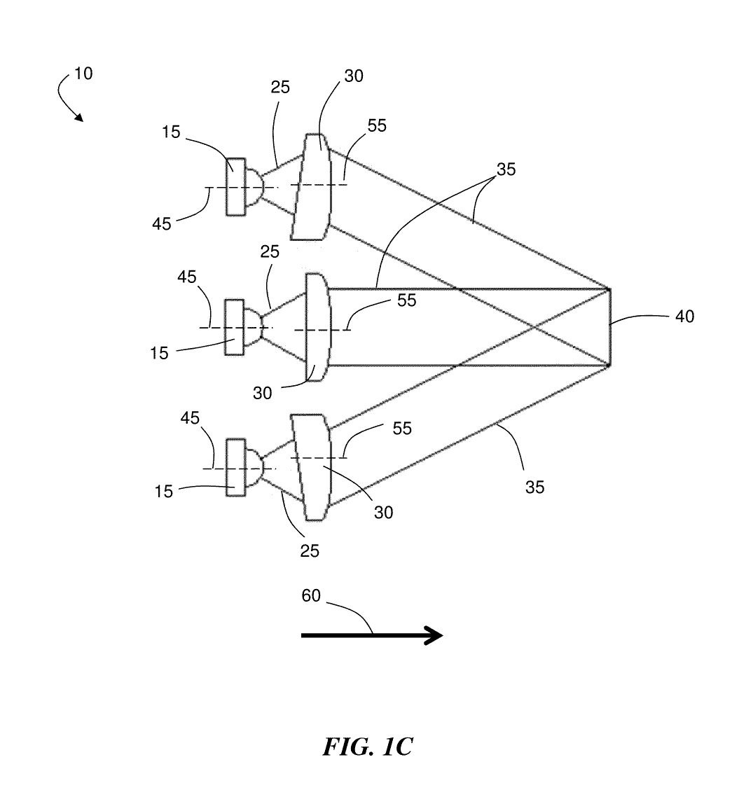

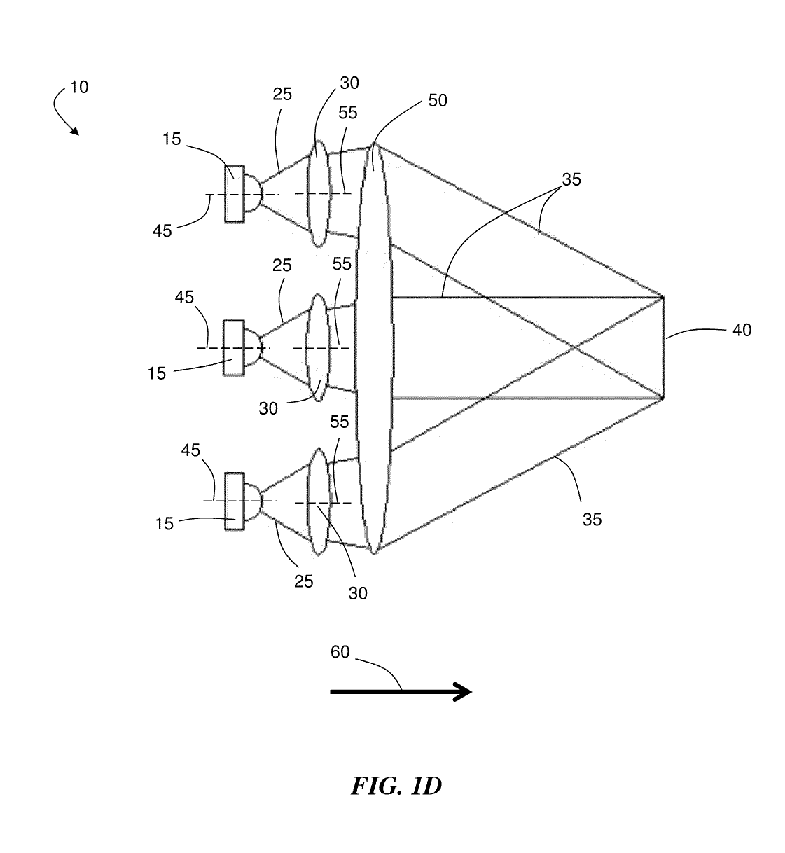

Non-limiting exemplary embodiments of inventive optical systems are shown in the cross-sectional schematic diagrams of FIGS. 1A-1D. In FIGS. 1A-1D, optical system 10 may include an array of collimating lenses positioned in front of an array of light-emitting diodes. The array of light-emitting devices can include any number of light-emitting devices. In certain embodiments, the array of light-emitting devices comprises at least 3, at least 4, at least 5, or more light-emitting devices. In certain embodiments, the nearest neighbor distance for each LED within the array is less than about 10 cm or less than about 1 cm.

Each light-emitting diode 15 in the array may have a non-rectangular emission area, which emits electromagnetic radiation 25. At least a portion of the emitted electromagnetic radiation 25, may be received by a collimating lens 30. In certain embodiments, each collimating lens 30 may be matched with an individual light-emitting diode in the array and may receive at least a portion of the electromagnetic radiation from that light-emitting diode, as shown in FIGS. 1A-1D. While FIGS. 1A-1D illustrate embodiments in which each LED is coupled with a single collimating lenses such that each lens receives electromagnetic radiation from a single LED, in other embodiments, additional collimating lenses may be present. For example, in certain embodiments, one or more LED within the LED array may be coupled with two or more collimating lenses, such that the two or more collimating lenses are each configured to receive light from the same, single LED within the LED array.

The collimating lenses can be configured to redirect the electromagnetic radiation emitted from the light-emitting diodes. The redirected light may overlap at an intersection plane. The intersection plane can correspond to a plane in space at which the electromagnetic radiation emitted from the light-emitting diodes (which can be redirected by the collimating lenses) at least partially overlaps. For example, in the embodiments illustrated in FIGS. 1A-1D, electromagnetic radiation emitted by light-emitting diodes 15 intersects at intersection plane 40. In certain embodiments, an image may be formed at the intersection plane. The image may have a shape substantially similar to the sum of the emission areas of the light-emitting diodes. Electromagnetic radiation that overlaps at the intersection plane may be manipulated further downstream to produce an illumination at a surface, as described in more detail elsewhere.

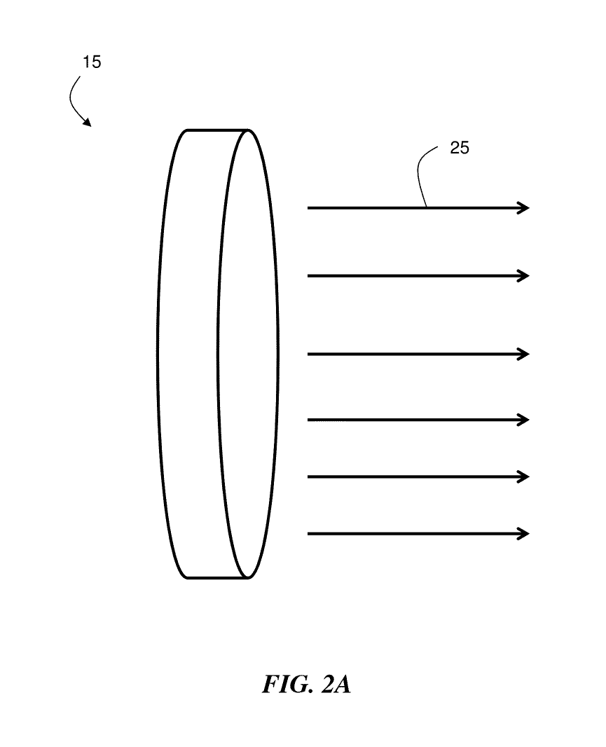

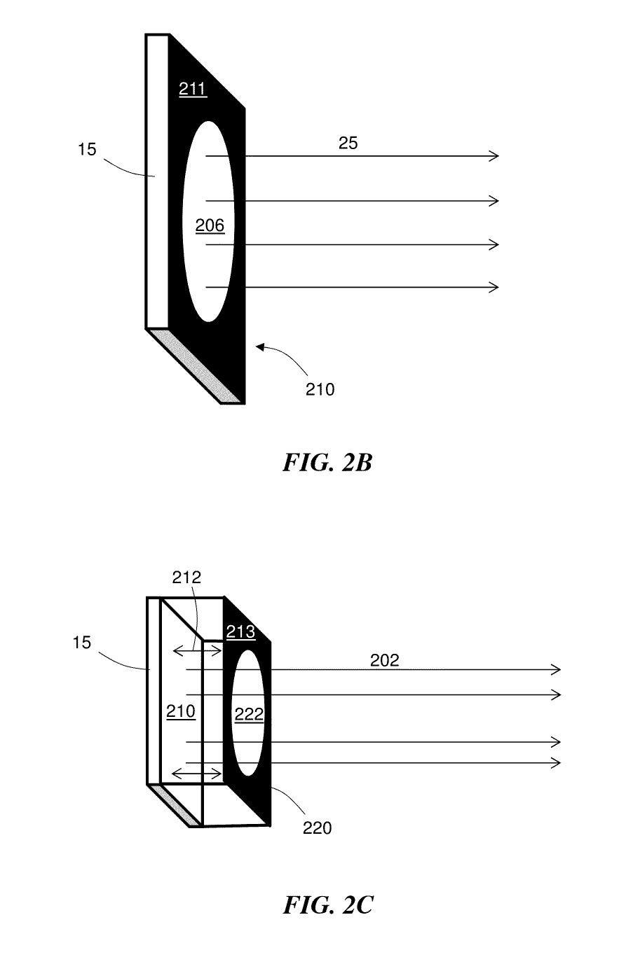

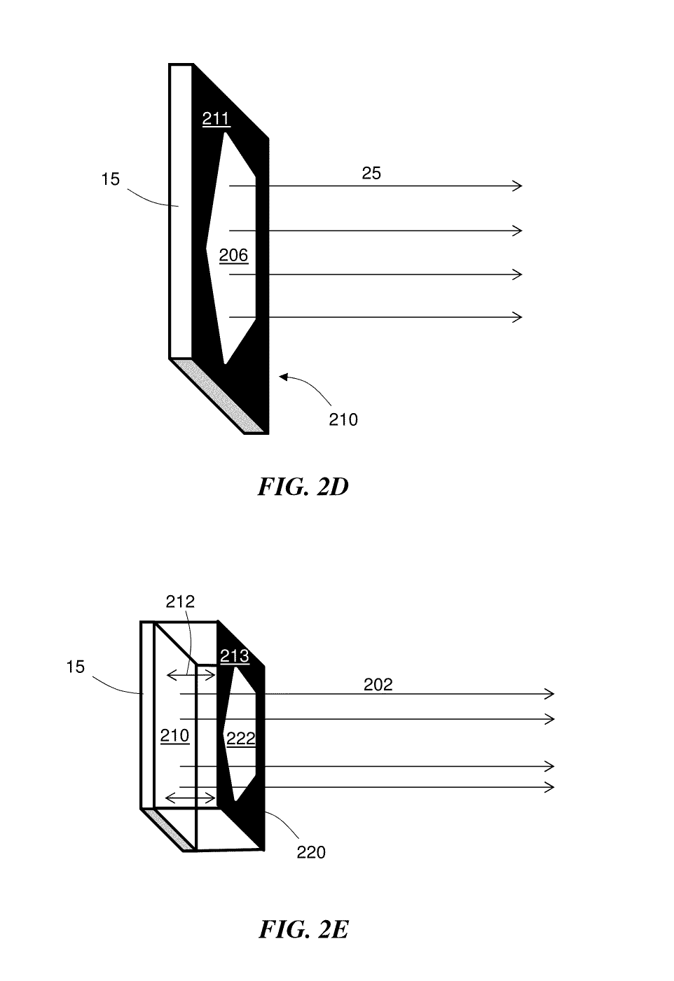

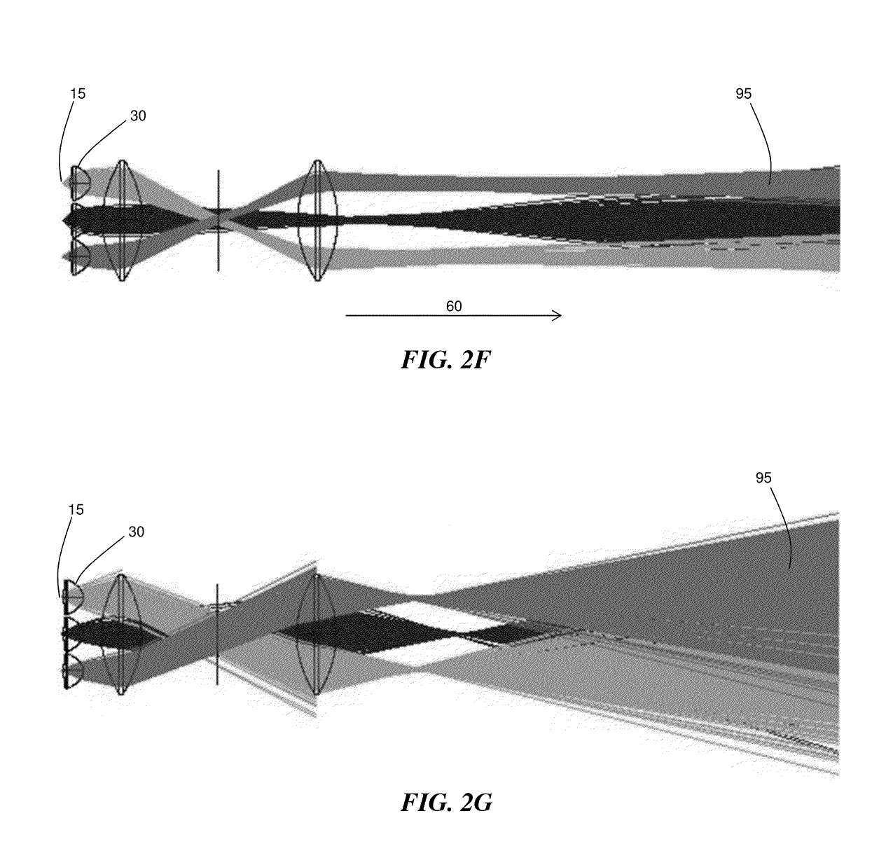

One or more (e.g., all) of the light-emitting diodes in the optical system can have a non-rectangular emission area. The emission area of a light-emitting diode generally refers to the area of the light-emitting diode from which electromagnetic radiation generated by the light-generating region of the light-emitting diode is emitted out of the light-emitting diode. As one example, the emission area of a light-emitting diode could be the same shape as the light-emitting diode die. For example, the emission area can be the top surface of the light-emitting diode die through which light generated by the light-generating region of the light-emitting diode is emitted, as is illustrated in FIG. 2A. In certain embodiments, a non-rectangular emission area can be formed by positioning a non-rectangular aperture on or close to the emission surface of the light-emitting diode, as illustrated in FIGS. 2B-2E. In still other embodiments, a non-rectangular emission area can be formed by selectively activating only a portion of the light-generating region to produce a non-rectangular active emission area during use. Descriptions of such embodiments are provided in more detail below.

A non-rectangular emission area can produce a non-rectangular image, whose shape is substantially similar to the shape of the emission area. For example, a circular emission area can produce a circular image. It should be understood that the invention is not limited to the use of circular emission areas and that improved performance can also be achieved using other non-rectangular emission area. In general the non-rectangular emission area may have any suitable shape to achieve the desired characteristics. For example, to achieve a substantially circular illumination at a surface, the light-emitting diode may be a regular polygon with six sides.

In some embodiments, the light-emitting diode can include an emission area having a shape that, while not perfectly circular, is substantially circular. In some embodiments, the light-emitting diode can include an emission area that has an elliptical shape, an ellipsoidal shape, or a shape that otherwise includes curved edges. In some embodiments, the emission area of the light-emitting diode can be in the shape of a polygon with at least 5 sides (e.g., a polygon with at least 6, at least 7, at least 8, at least 9, at least 10, at least 15, at least 20, at least 50, or at least 100 sides). In some embodiments, the emission area can include fewer than 1000 or fewer than 100 sides. Not wishing to be bound by any particular theory, it is believed that the use of an emitter including a polygonal emission area having 5 or more sides can approximate the effect observed in systems employing circular emission area geometries, with a greater number of polygon sides more closely approximating the performance of a circular emission surface. In some embodiments in which the shape of the emission area is polygonal, the polygon can be a substantially regular polygon. Of course, it should be understood that the invention is not limited to the use of emission areas in the shape of substantially regular polygons, and, in other embodiments, the emission area can be in the shape of an irregular polygon.

In addition to being non-rectangular, the emission area may have any suitable area to achieve the desired illumination. In some embodiments, the light-emitting diodes described herein can be configured such that the emission area has a relatively large emission surface area. For example, the emission area can have an emission surface area of at least about 1 mm², at least about 5 mm², at least about 10 mm², or at least about 100 mm² in some embodiments. The use of light-emitting diodes with large emission surface areas is not required, however, and in other embodiments, light-emitting diodes with smaller emission surface areas can be employed.

In some cases the light-emitting diodes that form the array may be uniform in shape. For example, each light-emitting diode of the array may be circular. In other cases, the light-emitting diodes may be non-uniform with respect to shape. For instance, some light-emitting diodes may be circular and others may be a regular polygon. In certain embodiments, each light-emitting diodes in the array may have the same emission area. In other instances, the light-emitting diodes may have different emission areas. For example, in an array containing seven light-emitting diodes, two light-emitting diodes may have an emission area of 2 mm² while the others may have an emission area of 6 mm². In general the light-emitting diodes in the array may have any suitable combination of shape and emission area to achieve the desired properties.

As noted above, the optical system of the present invention may contain light-emitting diodes arranged in an array. The array may have an outer perimeter determined by the configuration of the light-emitting diodes, which give the array its shape. For example, an array of six light-emitting diodes may be arranged in a hexagonal configuration. In this case, the outer perimeter may be described as a hexagon. In other embodiments, an array of six light-emitting diodes may be arranged in a pentagonal configuration, where one light-emitting diode is surrounded by the other five light-emitting diodes. In this case, the outer perimeter, and thereby the shape of the array, may be described as a pentagon.

It should be understood that the invention is not limited to the use of circular array configurations and that improved performance can also be achieved using other non-circular configurations, including arrays having three or more light-emitting diodes arranged in any configuration. In general the array may have any suitable shape to produce the desired illumination. For example, to achieve a substantially circular illumination at a surface, the outer perimeter of the array may be non-rectangular (e.g., a regular polygon with six sides). In some embodiments, the outer perimeter of the array may be approximately circular, such that the outer perimeter may occupy a given area of an imaginary circle drawn to intersect at least two vertices of the outer perimeter of the array. For instance, the outer perimeter of the array may occupy at least about 40% (e.g., at least about 45%, at least about 55%, at least about 65%, at least about 75%, at least about 85%) of the area of its circumcircle. In other instances, the outer perimeter may occupy at least about 40% (e.g., at least about 45%, at least about 55%, at least about 65%, at least about 75%, at least about 85%) of the area of its minimum covering circle. In other embodiments, the array may have a shape that, while not perfectly circular, is substantially circular. In some embodiments, the array may have an elliptical shape, an ellipsoidal shape, or a shape that otherwise includes curved edges.

In some embodiments, the array can be in the shape of a polygon with at least 5 sides (e.g., a polygon with at least 6, at least 7, at least 8, at least 9, at least 10, at least 15, at least 20, at least 50, or at least 100 sides). In some embodiments, the array can include fewer than 1000 or fewer than 100 sides. Not wishing to be bound by any particular theory, it is believed that the use of a polygonal array having 5 or more sides can approximate the effect observed in systems employing circular array geometries, with a greater number of polygon sides more closely approximating the performance of a circular array. In some embodiments in which the shape of the array is polygonal, the polygon can be a substantially regular polygon. Of course, it should be understood that the invention is not limited to the use of an array in the shape of substantially regular polygons, and, in other embodiments, the array can be in the shape of an irregular polygon.

In some embodiments, the optical system, as described herein, may have an optical axis. The optical axis of the system generally refers to an imaginary line parallel to the path through which electromagnetic radiation propagates through the optical system. As illustrated in FIG. 1A, and in accordance with certain embodiments, the light-emitting diodes in the array are oriented at an angle relative to the optical axis, and the optical axes of the light-emitting diodes are non-parallel to each other. In general, the orientation of the optical axes of the light-emitting diodes may be of any suitable degree relative to the optical axis to achieve the desired illumination. For example, one or more light-emitting diodes within the system may have an optical axis that is rotated, (relative to the optical axis of the system and/or relative to the optical axis of at least one other light-emitting diode within the system), by at least 5°, at least 20°, at least 45°, or at least 60°. In certain embodiments, the light-emitting diodes within the array may be oriented such that their optical axes are uniform with respect to rotation about the optical axis of the system. For example, each light-emitting diode of the array may have an optical axis that is rotated by about 13° relative to the optical axis of the system. In other embodiments, the optical axes of the light-emitting diodes may be rotated about the optical axis of the system in a non-uniform manner. For instance, some light-emitting diodes within the array may have optical axes that are rotated relative to the optical axis of the system by 35° while light-emitting diodes within the array may have optical axes that are rotated relative to the optical axis of the system by 15°.

The optical system may contain collimating lenses arranged in an array. In some embodiments, the collimating lens array may have the same configuration (e.g. shape, area, number, and/or rotation around the optical axis of the system) as the light-emitting diodes within the light-emitting diode array. In other instances, the collimating lens array may have a different configuration. For example, the array of collimating lenses may differ in respect to number of elements (i.e., number of lenses) in the array, array area, and array shape. In certain embodiments, the rotation of the optical axis of one or more (e.g., all) of the collimating lenses within the system can be substantially similar to (e.g., within 5° of, within 3° of, or within 1° of) the rotation of the optical axis of the light-emitting device (relative to the optical axis of the system) from which that collimating lens is configured to receive electromagnetic radiation.

In some embodiments, collimating lenses are positioned to receive at least a portion of the electromagnetic radiation emitted from the light-emitting diodes in the array. In some cases, each collimating lens is associated with an individual light-emitting diode, such that at least a portion (or all) of the electromagnetic radiation received by a particular collimating lens within the array originates from a light-emitting diode with which that particular collimating lens is associated. In some such embodiments, the collimating lenses may be configured to receive any suitable percentage of the electromagnetic radiation emitted from the light-emitting diode with which the collimating lens is associated. In some embodiments, the percentage of electromagnetic radiation received by a collimating lens from the light-emitting diode with which the collimating lens is associated may be at least about 10% (e.g., at least about 20%, at least about 30%, at least about 40%, at least about 50%, at least about 60%, at least about 70%, at least about 80%, at least about 90%, or at least about 99%). In other cases, each collimating lens is not associated with an individual light-emitting diode and the electromagnetic radiation received by the collimating lens originates from at least two light-emitting diodes in the array. In this case, the array of collimating lenses may receive any suitable percentage of electromagnetic radiation from the array of light-emitting diodes.

In addition to receiving electromagnetic radiation, the collimating lenses may redirect at least a portion of the electromagnetic radiation received from the light-emitting diodes. In some cases, the collimating lenses can redirect the electromagnetic radiation by collimating at least a portion of the electromagnetic radiation. In other cases, the collimating lenses can redirect electromagnetic radiation by changing the angle at which the electromagnetic radiation is propagated. In some embodiments, the collimating lenses may redirect at least about 10% (e.g., at least about 20%, at least about 30%, at least about 40%, at least about 50%, at least about 60%, at least about 70%, at least about 80%, at least about 90%, or at least about 99%) of the electromagnetic radiation incident on the collimating lens.

In some embodiments, the position of the collimating lenses with respect to the light-emitting diode and in space may influence the properties of the redirected electromagnetic radiation. In certain embodiments, the collimating lenses may be positioned in front of the light-emitting diodes, such that the angular distribution of the redirected electromagnetic radiation is less than the angular distribution of the electron magnetic radiation emitted from the light-emitting diode. For example, in some instances, each collimating lens may be associated with an individual light-emitting diode as illustrated in FIG. 1A. The angular distribution of the electromagnetic radiation 35 from the individual light-emitting diode after it has passed through the collimating lens (i.e., after it has been redirected) can be less than the angular distribution of the electromagnetic radiation 25 from the light-emitting diode alone. In certain embodiments, the position of the collimating lenses relative to the light-emitting diodes along the optical axis of the system can determine the angular distribution of the redirected electromagnetic radiation. In some embodiments, the position of the collimating lenses along optical axis 60 of system 10 with respect to light-emitting diodes may determine the position in space where the redirected light is imaged and the shape of the resulting image. For example, the redirected electromagnetic radiation may be imaged at an intersection plane, such that the shape of the resulting image is substantially similar to the sum of the shape of the light-emitting diodes.

In some embodiments, the position of the collimating lenses relative to the light-emitting diodes along the optical axis of the system (e.g., optical axis 60 in FIG. 1A) can alter the orientation of the redirected light and the beam angle of the electromagnetic radiation emitted from the optical system. For example, in FIG. 2F, LEDs 15 are located relatively far away (along optical axis 60) from collimating lenses 30, resulting in diverging electromagnetic radiation beams emitted from collimating lenses 30 and a relatively narrow beam angle of electromagnetic radiation in region 95. Conversely, in FIG. 2G, LEDs 15 are located relatively close (along optical axis 60) to collimating lenses 30, resulting in converging electromagnetic radiation beams emitted from collimating lenses 30 and a relatively wide beam angle of electromagnetic radiation in region 95. In some embodiments, the orientation of the redirected light can influence the angle of the electromagnetic radiation (i.e. beam angle) emitted from the optical system. The array of collimating lenses may be moved in the z-axis to achieve a variable beam angle of electromagnetic radiation emitted from the optical system. In some embodiments, the distance between the light emitting diodes and the collimating lenses (along the optical axis of the system) within the collimating lens array may influence the optical efficiency at the intersection plane and/or far-field. In one example, the optical efficiency at the intersection plane and/or far-field may decrease as the distance between the light emitting diodes and the collimating lenses increases. In another example, the optical efficiency at the intersection plane and/or far-field may increase or stay the same as at the distance between the light emitting diodes and the collimating lenses increases.

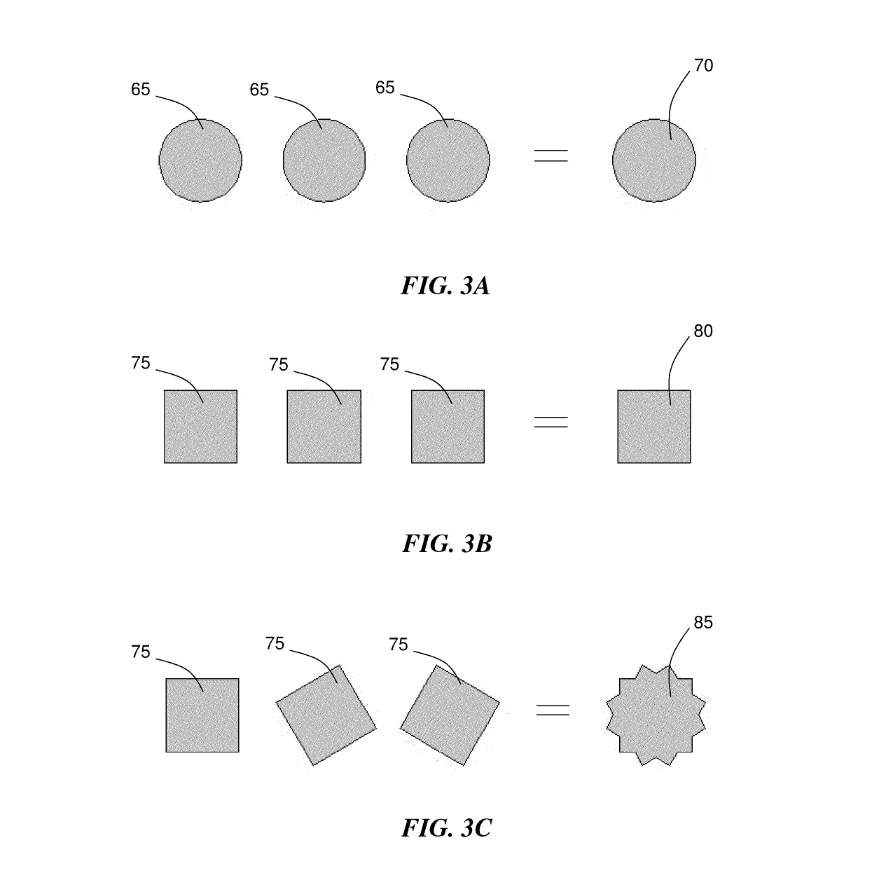

As described herein, the light-emitting diode array produces electromagnetic radiation that is redirected by the collimating lens array. In some embodiments, the collimating lenses may redirect the electromagnetic radiation, by any number of means, such that a plane, which is forward of the light-emitting diodes and collimating lenses, exists along the z-axis where at least a portion of the redirected electromagnetic radiation from each collimating lens overlaps. The plane in the z-axis where the redirected electromagnetic radiation overlaps is called the intersection plane. The electromagnetic radiation, which overlaps at the intersection plane, may be composed of at least a portion of the electromagnetic radiation from each of the light-emitting diodes in the light-emitting diode array. In other cases, electromagnetic radiation from at least a portion of the light-emitting diodes may not overlap at the intersection plane. In general, any suitable percentage of electromagnetic radiation from each light-emitting diode may overlap to form the intersection plane. In some embodiments, the image at the intersection plane may be the image of the light-emitting diodes, whose electromagnetic radiation overlap at the intersection plane. The shape of the image at the intersection plane may be a summation of the shapes of the emission areas of the light-emitting diodes, whose electromagnetic radiation emissions overlap at the intersection plane. For example, as illustrated in FIG. 3A, circular light-emitting diodes 65 may produce a circular image 70 at the intersection plane. Square light-emitting diodes 75 may produce a square image 80 at the intersection plane (as illustrated in FIG. 3B), whereas square light-emitting diodes 75, each rotated differently about the optical axis of the system, may produce a polygonal image 85 at the intersection plane (as illustrated in FIG. 3C).

Specific embodiments employed in the present invention to form an intersection plane are illustrated in FIGS. 1A-1D. In some embodiments, as illustrated in FIG. 1A, the optical axes 45 of the light-emitting diodes in the array may be oriented such that the optical axes of the light-emitting diodes are at an angle with respect to one another. In some cases, the orientation of the optical axes of the light-emitting diodes may be configured such that the electromagnetic radiation emitted by the light-emitting diodes overlaps at the intersection plane. In certain embodiments, each collimating lens may be associated with an individual light-emitting diode such that the optical axes of the collimating lens have the same orientation as the optical axes of the light-emitting diodes. For example, in FIG. 1A, the optical axis 55 of each collimating lens 30 is substantially parallel to the optical axis 45 of the light-emitting diode with which the collimating lens is associated. In addition, in FIG. 1A, collimating lenses 30 are oriented such that the optical axis of each collimating lens is at an angle relative to the optical axes of the other collimating lenses. In some embodiments, the orientation of the optical axes of the light-emitting diodes and the orientation of the optical axes of the collimating lenses may allow the electromagnetic radiation to overlap at an intersection plane. In other cases, the orientations of the optical axes of the collimating lenses, alone, may allow the electromagnetic radiation to overlap at the intersection plane.

In certain embodiments, to produce an intersection plane with the desired characteristics, at least a portion of the optical axes of the collimating lenses 30 may not be aligned (i.e., they may be offset) with the optical axes of light-emitting diodes 15, as shown, for example, in FIG. 1B. Non-alignment (i.e., offset) may occur when the optical axes of a light-emitting diode and the collimating lens with which it is coupled (e.g., 45A and 55A in FIG. 1B) do not connect to form a straight line. In some cases, the optical axis of the light-emitting diode and the optical axis of the collimating lens with which it is coupled (e.g., 45A and 55A) may be substantially parallel and separated by a distance that is orthogonal to the optical axes of the LED and the lens. For instance, in some embodiments, the optical axes of the LED and the collimating lens with which the LED is coupled may be separated by at least about 0.1 mm (e.g., at least about 0.2 mm, at least about 0.3 mm, at least about 0.4 mm, at least about 0.5 mm, at least about 0.6 mm, at least about 0.7 mm, at least about 0.8 mm). In other cases, the optical axes of the LED(s) and the collimating lens(es) may be at an angle relative to one another. For instance, in some embodiments, the relative angle may be at least about 1 degree (e.g., at least about 5 degrees, at least about 15 degrees, at least about 30 degrees, at least about 45 degrees, at least about 60 degrees, at least about 90, at least about 120 degrees, at about 150 degrees).

By configuring certain collimating lenses such that their optical axes (e.g., 55B) are not offset from the optical axes (e.g., 45B) of the light-emitting diodes with which they are paired, the electromagnetic radiation (e.g., 35B) output from the collimating lens may be redirected at angle that is substantially the same as the angle at which the electromagnetic radiation (e.g., 25B) entered the collimating lens. On the other hand, by configuring certain collimating lenses such that their optical axes are offset from the optical axes of the light-emitting diodes with which they are paired, the electromagnetic radiation (e.g., 35A) output from the collimating lens may be redirected at a different angle relative to the angle at which the electromagnetic radiation (e.g., 25A) enters the collimating lens. In another example the offset collimating lenses may receive at least a portion of the emitted electromagnetic radiation and redirect it such that the rays of the redirected electromagnetic radiation have a specific geometric orientation. In some cases, the collimating lens array may be offset from the light-emitting diode array, such that each collimating lens has the same offset. In other cases, each collimating lens in the array may be independently offset, such that each collimating lens may have the same or a different offset than other collimating lenses in the array. In some instances, at least a portion of the collimating lenses in the array may not be offset. For example, as illustrated in FIG. 1B, each collimating lens (e.g., 30A, 30B, 30C) is independently offset, such that 30A and 30C are offset, while 30B is not offset. In some cases, as shown in FIG. 1B, the collimating lenses may be offset and at least a portion of the light-emitting diodes may not be oriented at an angle with respect to one another. In other cases, at least a portion of the light-emitting diodes may be oriented at an angle with respect to one another. In certain embodiments, each collimating lens may be paired with an individual light-emitting diode and the offset of the collimating lens may be determined by the position of that light-emitting diode. For instance, the offset of the collimating lenses in FIG. 1A, might be determined by the angle of the light-emitting diodes relative to the optical axis of the system.

As illustrated in FIG. 1C, in certain embodiments, at least a portion of the collimating lenses may correspond to an integrated wedge. An integrated wedge can comprise, for example, a wedge-shaped collimating lens, in which the collimating lens may decrease in thickness (e.g., linearly decrease in thickness) from at least one end to another end (i.e., taper). In other embodiments, an integrated wedge may refer to a collimating lenses that is optically coupled to an optical transparent wedge shaped material. Regardless of how the wedge is integrated, the integrated wedge may change the angle of the emitted electromagnetic radiation such that the redirected electromagnetic radiation overlaps at an intersection plane with the desired properties. The change in the angle of the emitted electromagnetic radiation (i.e., deviation angle) may be tuned by the wedge angle (i.e., the angle between the surfaces that define the taper in thickness). Each integrated wedge may have the same wedge angle or have different wedge angles. Some collimating lenses may not have an integrated wedge (i.e., no wedge angle or taper in thickness). In some embodiments, the integrated wedge may have a specific orientation (e.g., with respect to the direction of the taper). In general, any suitable combination of wedge angles and wedge orientation, including no wedge angle, may be present in the collimating lens array.

In some embodiments, light-emitting diodes and collimating lenses may be arranged to form an intersection plane, where at least a portion of the emitted electromagnetic radiation overlaps. In certain embodiments, the intersection plane can be formed without electromagnetic radiation passing through and/or being redirected by an article (e.g., solid article). In some embodiments, the system is configured such that the light passes directly from the collimating lenses to the intersection plane without being redirected by a solid article, as illustrated, for example, in FIGS. 1A-1B. In certain embodiments, a solid article, in addition to the light-emitting diodes and collimating lenses, may be used to form an intersection plane. In some cases, the solid article may be positioned in front of the array of collimating lenses along the optical axis of the system (i.e., to the right of the array of collimating lenses along optical axis 60 in FIG. 1B). In other cases, the solid article may be positioned between the array of collimating lenses and the intersection plane. In general, the solid article may have any suitable position necessary to aid in the formation of an intersection plane. In some embodiments, the solid article may be a focusing lens. When a focusing lens is placed in front of the array of collimating lenses, the redirected electromagnetic radiation passes through the focusing lens. The focusing lens may receive the electromagnetic radiation from the collimating lens and focus the electromagnetic radiation such that electromagnetic radiation overlaps at the intersection plane. As illustrated in FIG. 1D, in some cases, the use of the focusing lens 50, may simplify the spatial orientation of the light-emitting diode array and the collimating lens array. For example, as in FIG. 1D, the optical axes of the light-emitting diodes and/or collimating lenses may not need to be at angle relative to one another. Moreover, there may not be a need to offset the light-emitting diodes and the collimating lenses. It should be understood that the solid article need not be a focusing lens and can have any suitable composition necessary to aid in the formation of an intersection plane.

In some embodiments, the redirected light may pass through a non-solid article (e.g., an aperture) before reaching the intersection plane. In some instances, the non-solid article, along the optical axis of the system (e.g., optical axis 60), may be between the collimating lenses and the intersection plane. In other instance, the non-solid article (e.g., aperture) may be positioned at or near the intersection plane, such that the aperture is in front of the array of collimating lenses and the solid article (i.e., to the right of the array of collimating lenses 30 and lens 50 in FIG. 1D), when present. In some cases, the non-solid article is an aperture. When present the aperture may influence the shape of the electromagnetic radiation at the intersection plane. For example, a substantially circular aperture may produce a substantially circular image at the intersection plane. It should be understood that the shape of the aperture is not limited to circular and that the shape of the aperture may be selected to achieve the desired illumination.

As described herein, the electromagnetic radiation at the intersection plane may have a defined shape, optical efficiency, and/or orientation. In some embodiments, the image at the intersection plane may be determined by the summation of emission area of each light-emitting diode in the light-emitting diode array, as shown in FIGS. 3A-3C. For example, a circular array of light-emitting diodes with square emission areas may produce a square image at the intersection plane. In another example, an array of light-emitting diodes with non-rectangular emission areas (e.g., polygon with at least 5 sides, substantially regular polygon, substantially circular) may produce a non-rectangular image (e.g., polygon with at least 5 sides, substantially regular polygon, substantially circular, respectively) at the intersection plane. In some instances, the presence or absence of a non-solid article (e.g., aperture) may influence the optical efficiency (i.e., percentage of the total flux emitted by all light-emitting diodes that is collected at the intersection plane) of the system at the intersection plane.

In some embodiments, the electromagnetic radiation at the intersection plane may be in an image-space telecentric configuration (i.e., the electromagnetic radiation beams are parallel to the optical axis of the system). Without being bound by theory, it is believed that since the chief rays of electromagnetic radiation intersect at the intersection plane, the electromagnetic beams emitted from the optical system maintain the characteristic of being parallel to the optical system, which may prevent separation of the electromagnetic radiation beams at a far-field position (e.g., illumination at a surface downstream).

As noted above, at least a portion of the electromagnetic radiation that passes through the intersection plane may illuminate a surface downstream to produce a far-field illumination. In some embodiments, the far-field illumination has a defined shaped that is substantially similar to the image at the intersection plane. In other words, the same factors that determine the shape of the electromagnetic radiation at the intersection plane (e.g., shape of the emission areas of the light-emitting diodes, shape of the array, presence of an aperture, etc.) may also, in certain embodiments, determine the shape of the far-field illumination. For example, a non-rectangular image (e.g., polygon with at least 5 sides, a regular polygon, a substantially circular) at the intersection plane may produce a non-rectangular far-field illumination (e.g., polygon with at least 5 sides, a regular polygon, a substantially circular, respectively). In certain embodiments, at least a portion of the electromagnetic radiation that passes through the intersection plane may pass through a solid article before illumination a surface downstream. The solid article may be used to aid in the formation of a far-field illumination with an image that is substantially similar to the image at the intersection plane. In some embodiments, the solid article is a projection lens. The projection lens may be positioned between the intersection plane and the illuminated surface downstream. In some cases, the solid article may be positioned at a defined position relative to the intersection plane. For instance, the projection lens may be placed in front of the intersection plane with a defined distance, along the z-axis, away from the intersection plane (e.g., less than one focal length, one focal length, more than one focal length). In certain embodiments, more than one solid article may be positioned between the intersection plane and the illuminated surface along the z-axis. In one example, more than one projection lenses (e.g., two projection lenses or more) may be positioned in between the intersection plane and the illuminated surface. Each solid article (e.g., projection lens) or the group of solid articles (e.g., a system with two or more projection lenses) may have a defined distance, along the optical axis of the system, away from the intersection plane.

In some embodiments, the electromagnetic radiation emitted from the optical system may be in an image-space telecentric configuration. In other words, the electromagnetic radiation that passes through the intersection plane, and optionally solid articles, may arrive in an image-space telecentric configuration at a surface downstream. The electromagnetic radiation emitted from the optical system may also have a defined optical efficiency (i.e., percentage of the total flux emitted by all light-emitting diodes that is collected at a position far-field). For instance, the electromagnetic radiation emitted from the optical system may have an optical efficiency at least about 50% (e.g., at least about 60%, at least about 70%, at least about 80%, at least about 90%, and/or, in certain embodiments, up to about 95%). In some instances, the optical efficiency of the optical system may be substantially the same as the optical efficiency at the intersection plane.

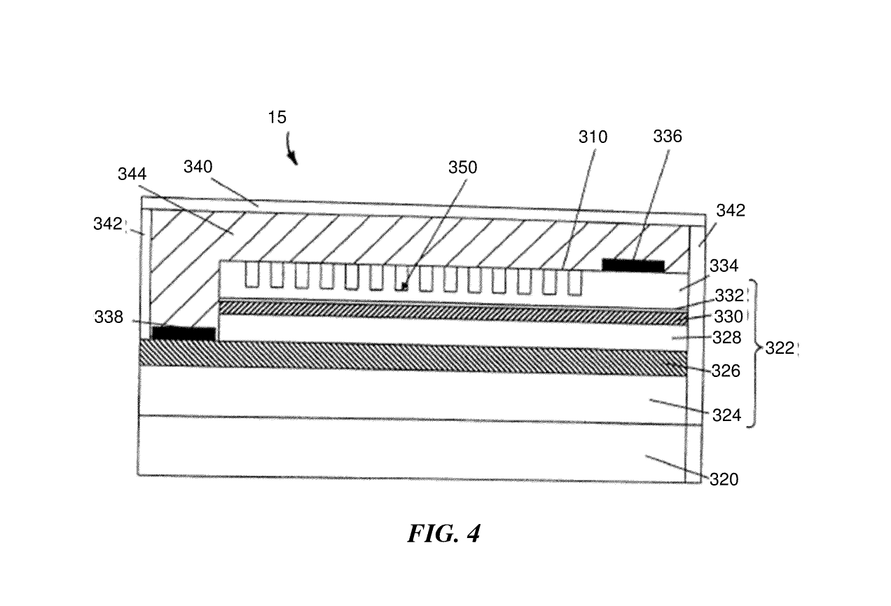

FIG. 4 includes an exemplary cross-sectional schematic illustration of light-emitting diode 15 in the form of a packaged die, which can be used in accordance with certain embodiments described herein. In FIG. 4, light-emitting diode 15 can include a multi-layer stack 322 disposed on a submount 320. As illustrated in this set of embodiments, multi-layer stack 322 includes a 320 nm thick silicon doped (n-doped) GaN layer 334 having a pattern of openings 350 in its upper area 310. Multi-layer stack 322 can also include, as shown in FIG. 4, a bonding layer 324, a 100 nm thick silver layer 326, a 40 nm thick magnesium doped (p-doped) GaN layer 328, a 120 nm thick light-generating region 330 formed of multiple InGaN/GaN quantum wells, and a AlGaN layer 332. As illustrated in FIG. 4, an n-side contact pad 336 can be disposed on layer 334, and a p-side contact pad 338 can be disposed on layer 326. As illustrated, an encapsulant material (e.g., epoxy having an index of refraction of 1.5) 344 can be present between layer 334 and a cover slip 340 and supports 342. In the set of embodiments illustrated in FIG. 4, layer 344 does not extend into openings 350.

Electromagnetic radiation can be generated by light-emitting diode 15 as follows. P-side contact pad 338 can be held at a positive potential relative to n-side contact pad 336, which can cause electrical current to be injected into light-emitting diode 15. As the electrical current passes through light-generating region 330, electrons from n-doped layer 334 can combine in region 330 with holes from p-doped layer 328, which can cause region 330 to generate electromagnetic radiation. Light-generating region 330 can contain a multitude of point dipole radiation sources that emit electromagnetic radiation (e.g., isotropically) within the region 330 with a spectrum of wavelengths characteristic of the material from which light-generating region 330 is formed. For InGaN/GaN quantum wells, the spectrum of wavelengths of electromagnetic radiation generated by region 330 can have a peak wavelength of about 445 nanometers (nm) and a full width at half maximum (FWHM) of about 30 nm.

It is to be noted that the charge carriers in p-doped layer 328 generally have relatively low mobility compared to the charge carriers in the n-doped semiconductor layer 334. As a result, placing silver layer 326 (which is conductive) along the surface of p-doped layer 328 can enhance the uniformity of charge injection from contact pad 338 into p-doped layer 328 and light-generating region 330. This can also reduce the electrical resistance of LED 15 and/or increase the injection efficiency of LED 15. Because of the relatively high charge carrier mobility of the n-doped layer 334, electrons can spread relatively quickly from n-side contact pad 336 throughout layers 332 and 334, so that the current density within the light-generating region 330 is substantially uniform across the region 330. It is also to be noted that silver layer 326 has relatively high thermal conductivity, allowing layer 326 to act as a heat sink for LED 15 (to transfer heat vertically from the multi-layer stack 322 to submount 320).

At least some of the light that is generated by region 330 can be directed toward silver layer 326. This light can be reflected by layer 326 and emerge from LED 15 via surface 310, or can be reflected by layer 326 and then absorbed within the semiconductor material in LED 15 to produce an electron-hole pair that can combine in region 330, causing region 330 to generate light. Similarly, at least some of the light that is generated by region 330 can be directed toward pad 336. The underside of pad 336 can be formed of a material (e.g., a Ti/Al/Ni/Au alloy) that can reflect at least some of the light generated by light-generating region 330. Accordingly, light directed to pad 336 can be reflected by pad 336 and subsequently emerge from LED 15 via surface 310 (e.g., by being reflected from silver layer 326), or light directed to pad 336 can be reflected by pad 336 and then absorbed within the semiconductor material in LED 15 to produce an electron-hole pair that can combine in region 330, which can cause region 330 to generate light (e.g., with or without being reflected by silver layer 326).

In some embodiments, emitting surface 310 of the light-emitting diode has a dielectric function that varies spatially which can improve the extraction efficiency of light generated by the light-emitting diode and may enable high power levels. For example, the dielectric function can vary spatially according to a pattern. The pattern may be periodic (e.g., having a simple repeat cell, or having a complex repeat super-cell), periodic with de-tuning, or non-periodic. Examples of non-periodic patterns include quasi-crystal patterns, for example, quasi-crystal patterns having 8-fold symmetry. In certain embodiments, the emitting surface is patterned with openings which can form a photonic lattice. Suitable light-emitting diodes having a dielectric function that varies spatially (e.g., a photonic lattice) have been described in, for example, U.S. Pat. No. 6,831,302 B2, entitled “Light-emitting Devices with Improved Extraction Efficiency,” filed on Nov. 26, 2003, which is herein incorporated by reference in its entirety.

In some embodiments, performance can be enhanced by placing cover slip 340 close to the top surface of the light-emitting diode or by eliminating the cover slip 340 from the light-emitting diode package. In some embodiments, performance can be enhanced by replacing encapsulant material 344 with air such that the light-emitting diode emits directly into air.

While the light-emitting diode shown in FIG. 4 is illustrated as having the n-side contact pad 336 on the top of the LED and the p-side contact pad 338 is on the bottom of the light-emitting diode, it should be understood that the light-emitting diode in FIG. 4 is merely illustrative and that, in other embodiments (e.g., in embodiments in which the light-emitting diode is fabricated according to a flip-chip process), the p-side contact pad may be on top.

As noted above, the light-emitting diodes described herein can have a non-rectangular emission area, in certain embodiments. FIG. 2B is a perspective view schematic illustration of one such system in which an LED 15 comprising a non-rectangular emission area 206 is employed. In FIG. 2B, LED 15 comprises a top surface 210. Portion 211 of top surface 210 can be configured such that light is not emitted out of the LED through portion 211, using any of a variety of techniques, alone or in combination with each other, described in more detail below. In the set of embodiments illustrated in FIG. 2B, configuring LED 15 such that light is not emitted out of portion 211 creates a substantially circular emission area 206. While a circular emission area 206 is illustrated in FIG. 2B, in other embodiments, emission areas with other non-rectangular shapes can also be used, as described in more detail below.

In some embodiments, the shape of the emission area of the LED can be non-rectangular and can be defined by one or more features positioned over the top surface of the die. Such embodiments can be useful, for example, in cases where the LED die is square or otherwise rectangular, and it is desired to create an emission area of the LED that is non-rectangular (e.g., curved, 5-sided or greater polygonal (regular or irregular), etc.).

The emission area of an LED is said to be defined by a feature when the feature alters the shape of the light emitted from the LED surface, relative to the shape of the light that would be emitted from the LED in the absence of the feature. For example, an opaque electrical contact that does not allow light to be transmitted through it or diffracted around it would be said to define an emission surface. On the other hand, an opaque electrical contact in the form of a relatively thin wire which merely diffracts the light emitted from the LED such that the shape of the light emitted from the LED is not altered would not be said to define an emission surface.

A variety of techniques can be used to produce an emission surface having a desired shape (e.g., a non-rectangular shape) that is not substantially similar to the shape of the LED die. In some embodiments, opaque materials (e.g., electrical contacts) that do not substantially transmit light are positioned over (e.g., directly on) the top surface of the LED die. In such cases, the emission surface of the LED would not include the portions of the top surface of the LED that are covered by the opaque material. In some such cases, the emission area can correspond to the area that is not covered by the opaque material, assuming emission through the non-doped regions is not otherwise prevented. As a specific example, referring back to FIG. 2B, region 211 can comprise an opaque material (e.g., one or more electrical contacts) positioned over surface 210 such that emission area 206 remains uncovered.

As another example, the LED might include a top surface in which one or more regions of the top surface have been doped to reduce their electrical conductivities such that current is injected into (and light is emitted out of) the LED only through non-doped regions. In such cases, the emission surface would not include the doped areas of the top surface of the LED. In some such cases, the emission area can correspond to the area occupied by the non-doped regions, assuming emission through the non-doped regions is not otherwise prevented (e.g., by covering the non-doped regions with an opaque material). As one specific example, referring back to FIG. 1E, region 211 of top surface 210 can be doped such that the material within region 211 is incapable of substantially conducting electricity, while the area within emission area 206 remains undoped.

As yet another example, the LED might include non-ohmic materials positioned between electrical contacts and the top surface of the LED, which can prevent current from being transferred from the electrical contacts through the LED. In such cases, the emission surface would not include the areas of the top surface that are covered by the non-ohmic material. In some such cases, the emission area can correspond to the areas that are not covered by non-ohmic materials, assuming emission through the uncovered regions is not otherwise prevented (e.g., by doping or by covering with an opaque material). As a specific example, referring back to FIG. 2B, non-ohmic material can be positioned over region 211 of top surface 210 such that electricity cannot be transferred through region 211 is incapable of substantially conducting electricity, while the area within emission area 206 remains uncovered. In such an embodiments, when an electric potential is applied across LED 15, current will be transported only through region 206, and, thus, light will be emitted only through region 206.

In certain embodiments, the LED can be configured to have a non-rectangular emission area by positioning a packaging layer comprising an aperture (referred to herein as the emitter output aperture) over the emission surface of the LED. FIG. 2C is a perspective view illustration of a system in which an emitter output aperture is employed. In FIG. 2C, LED 15 comprises a substantially rectangular top surface 210. LED package layer 220, which is positioned over top surface 210, includes emitter output aperture 222, which is circular in shape. During operation, portion 202 of the electromagnetic radiation emitted by LED 15 is transmitted through aperture 222. In certain embodiments, portion 212 can be reflected by material 213 back toward top surface 210. Such reflection can be achieved when material 213 is a reflective material such as a metal. By arranging emitter output aperture 222 proximate LED 15, a circular emission profile can be created from substantially rectangular top surface 210.

In certain embodiments, the emitter output aperture and the top surface of the LED can be positioned relatively close to one another. In some embodiments, the shortest distance between the emitter output aperture and a light-emitting die is less than about 1 centimeter, less than about 1 millimeter, less than about 500 microns, or less than about 100 microns. In certain embodiments, positioning the emitter output aperture close to the LED can reduce the amount of light that is lost from the system.

The emission surface of the LED and/or the emitter output aperture associated with the LED can be configured to have any desirable shape. As one particular example, a light-emitting diode with a circular emission surface could be used (e.g., in a system with a circular input aperture), such as emission area 206 illustrated in FIG. 2B. In some embodiments, a substantially circular emitter output aperture can be associated with the LED, such as emitter output aperture 222 illustrated in FIG. 2C.

It should be understood that the invention is not limited to the use of circular emission surfaces and circular emitter output apertures, and that improved performance can also be achieved using other non-square emission surface shapes and/or other non-square emitter output aperture shapes (including non-rectangular emission surface shapes and/or non-rectangular emitter output aperture shapes). In some embodiments, the light-emitting diode can include an emission surface and/or an emitter output aperture having a shape that, while not perfectly circular, is substantially circular. In some embodiments, the light-emitting diode can include an emission surface and/or an emitter output aperture that has an elliptical shape, an ellipsoidal shape, or a shape that otherwise includes curved edges.

In some embodiments, the emission surface of the light-emitting diode and/or an emitter output aperture associated with a light-emitting diode can be in the shape of a polygon with at least 5 sides (e.g., a polygon with at least 6, at least 7, at least 8, at least 9, at least 10, at least 15, at least 20, at least 50, or at least 100 sides). In some embodiments, the emission surface and/or emitter output aperture of the light-emitting diode can include fewer than 1000 or fewer than 100 sides. Not wishing to be bound by any particular theory, it is believed that the use of an emitter including a polygonal emission surface having 5 or more sides and/or emitter output aperture can approximate the effect observed in systems employing circular emission surface geometries, with a greater number of polygon sides more closely approximating the performance of a circular emission surface. In some embodiments in which the shape of the emission surface and/or emitter output aperture is polygonal, the polygon can be a substantially regular polygon.

As one example, FIG. 2D is a perspective view schematic illustration of a system in which LED 15 includes an emission surface in the shape of a five-sided polygon. Specifically, emission area 206 in FIG. 2D is a substantially regular pentagon. FIG. 2E is a perspective view schematic illustration of a system in which emitter output aperture 222 is in the shape of a substantially regular pentagon. Not wishing to be bound by any particular theory, it is believed that the use of emission surfaces and/or emitter output apertures with substantially regular polygonal shapes more closely approximates the use of devices that have circular emission surfaces. Of course, it should be understood that the invention is not limited to the use of emission surfaces and emitter output apertures in the shape of substantially regular polygons, and, in other embodiments, the emission surface can be in the shape of an irregular polygon.

While several embodiments have been described in which various materials (e.g., opaque materials such as electrical contacts, doped materials, and the like) are used to define the emission surface of the LEDs described herein, it should be understood that non-rectangular emission surfaces can also be created by processing the light-emitting die such that the die itself has a desired emission surface shape. In some such embodiments, the shape of the LED die can substantially correspond to the shape of the emission surface. For example, in some embodiments, the LED die can be non-rectangular (e.g., having a shape corresponding to any of the shapes of the emission surfaces described elsewhere herein). In some embodiments, the LED die can be curved (e.g., circular, substantially circular, elliptical, ellipsoidal, or otherwise curved), polygonal with at least 5 sides, or any other shape described herein. As one example, FIG. 2A includes a schematic illustration of an LED including a substantially circular die. While such dies can be used in the systems and methods described herein, their use is often not preferred because fabricating non-rectangular dies can be prohibitively expensive and complicated, in many instances.

The following examples are intended to illustrate certain embodiments of the present invention, but do not exemplify the full scope of the invention.

### EXAMPLE 1

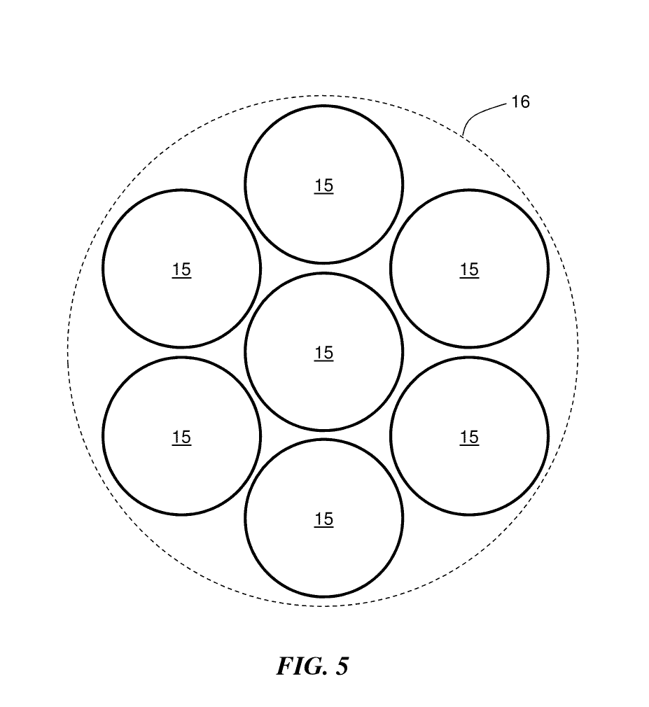

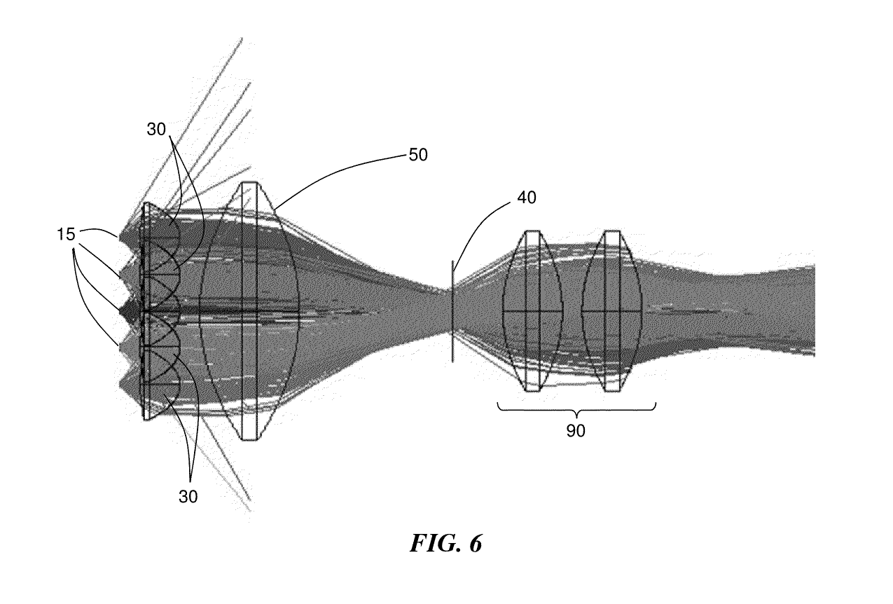

This example describes the uses of circular light-emitting diodes to produce circular illumination at the intersection plane and at the far-field. Zemax optical software was used to simulate a far-field illumination system using circular light-emitting diodes. As illustrated in FIG. 5, seven light-emitting diodes 15, each having a Lambertian emission profile, were aligned in an array with a substantially circular outer perimeter 16. The arrangement of the optical system can be seen in FIG. 6. In this simulation, each light-emitting diode had a collimating lens 30 placed in front of its emission area. A focusing lens 50 was used to re-direct the light passing through the collimation lenses such that the light beams intersected at the intersection plane 40. A two-element projection lens 90 was positioned one focal length forward of intersection plane 40. All lenses in the optical system were assumed to have an anti-reflection (AR) coating on each optical surface. Baseline performance of the optical system was simulated using circular light-emitting diodes with a 7 mm² emission area and can be seen in Table 1. The optical efficiency at the intersection plane was calculated by dividing the flux collected at intersection plane which passes through entire optical system by the total flux emitted by all light-emitting diodes. The optical efficiency at the far-field was calculated by dividing the flux collected at the far-field by the total flux emitted by all light-emitting diodes.

TABLE 1
Summary of simulation results from Example 1

| | Distance | | | |
|---|---|---|---|---|
| | Between | | | |
| | LED | | | |
| | and | Optical Efficiency | Optical | Far-field |
| | Collimation | at Intersection | Efficiency at | FWHM Beam |
| LED | Lens | Plane | Far-field | Angle |
| 7 mm², | 10 mm | 64% | 62% | 16° |
| circular | | | | |
| 7 mm², | 4 mm | 86% | 82% | 40° |
| circular | | | | |

### EXAMPLE 2

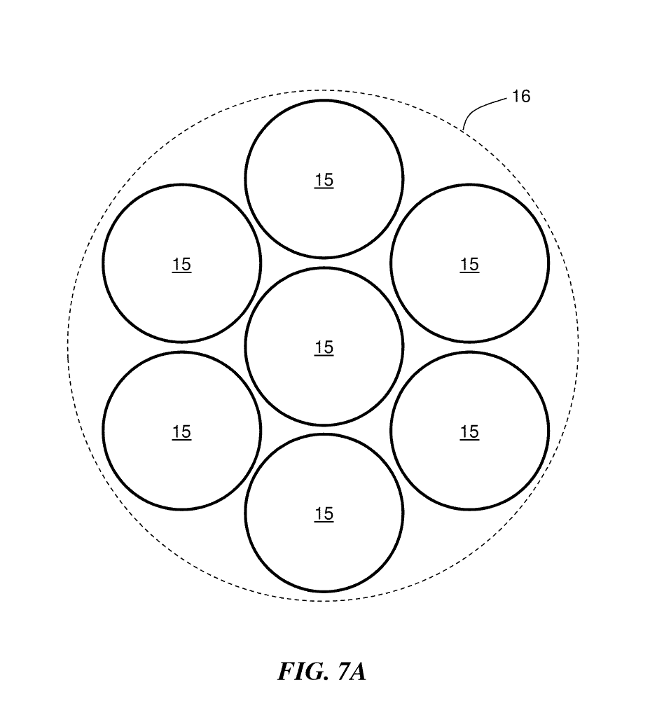

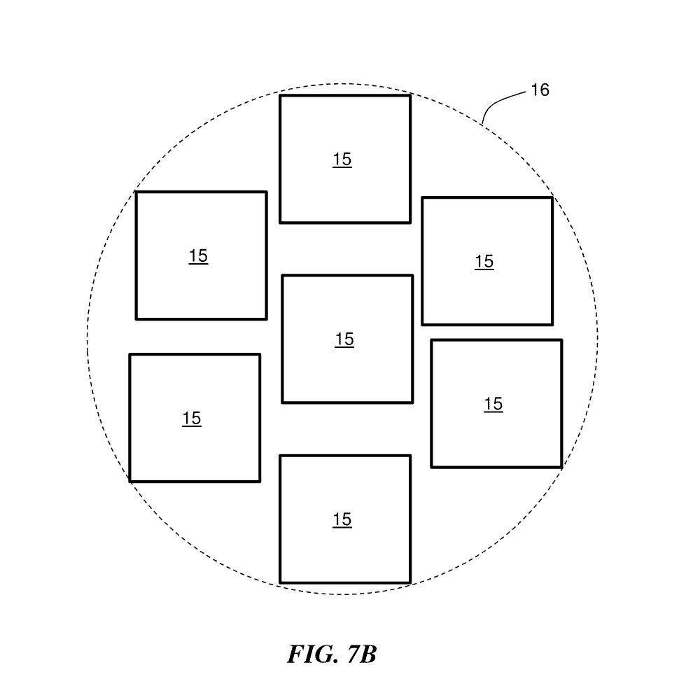

This example describes the comparison of far-field illumination produced by three different arrays of light-emitting diodes with different shapes. Zemax optical software was used to simulate the far-field illumination systems. The optical systems were simulated in narrow-beam configuration with the following light-emitting diode arrays: i) circular light-emitting diodes having an emission areas of 7 mm² as illustrated in FIG. 7A, ii) square light-emitting diodes, each with no rotation about their optical axes, having emission areas of 7 mm² as illustrated in FIG. 7B, and iii) square light-emitting diodes, each with rotation about their optical axes, having an emission areas of 7 mm² as illustrated in FIG. 7C. The electromagnetic radiation produced at the intersection plane and far-field with circular light-emitting diodes was substantially more circular than square light-emitting diodes, rotated square light-emitting diodes, and square light-emitting diodes with a circular aperture.

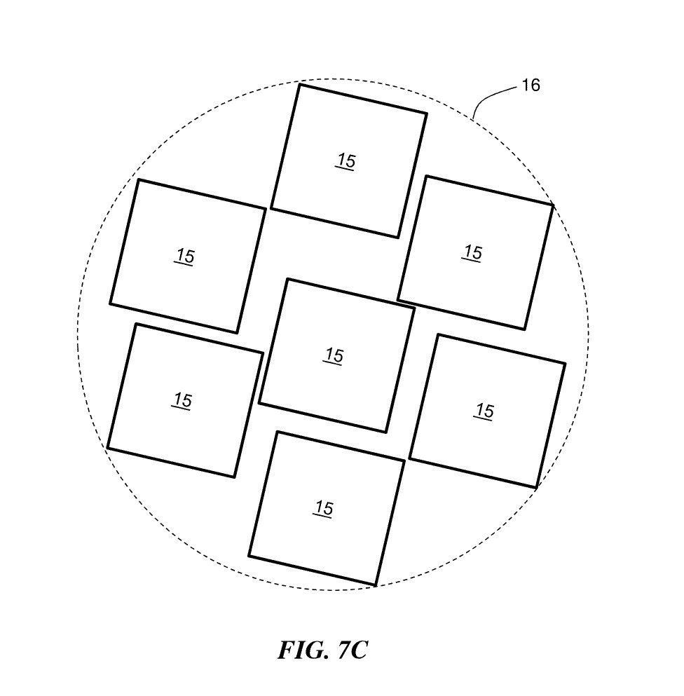

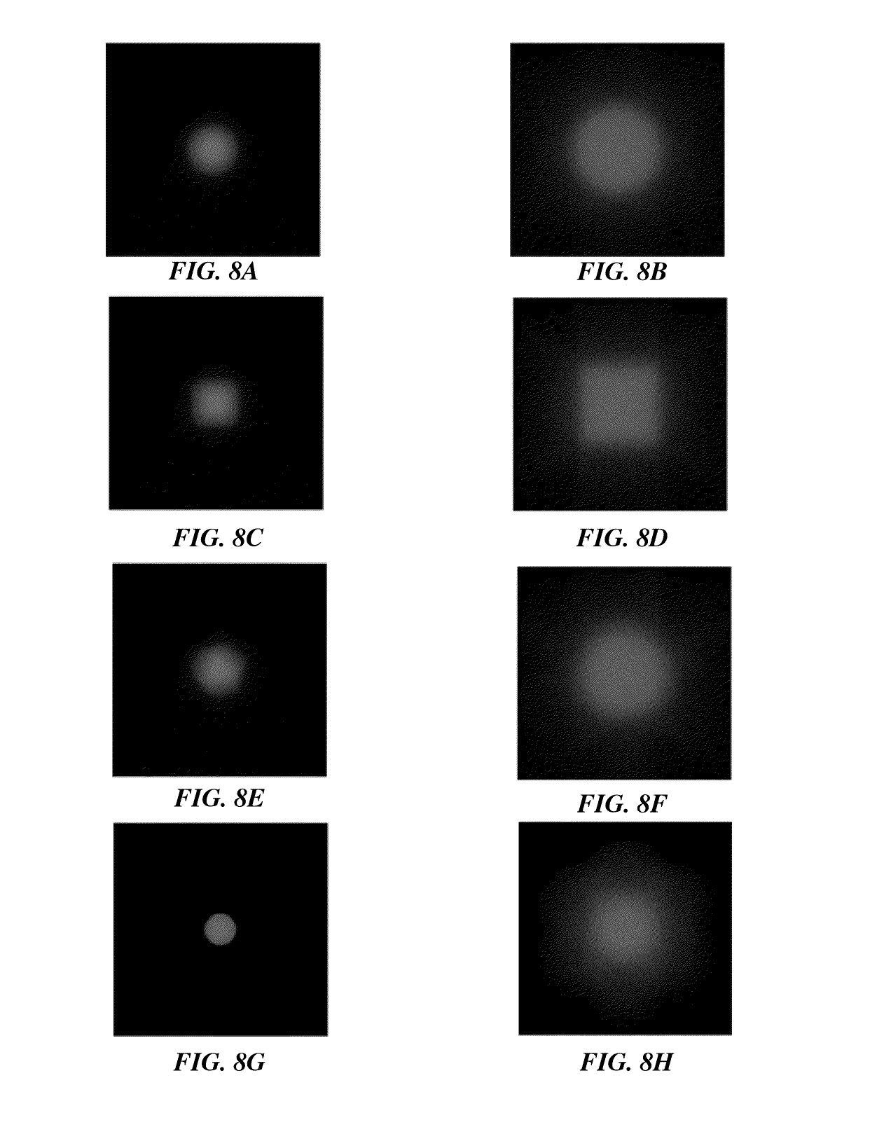

The simulated system employing circular light-emitting diodes having emission areas of 7 mm² exhibited an optical efficiency of about 67% at the intersection plane for a narrow-beam configuration, and an optical efficiency of about 65% at the far-field. The shape of the illumination at the intersection plane and far-field were both circular as illustrated in FIGS. 8A and 8B, respectively.

When the simulated system used square light-emitting diodes, each with no rotation about the optical axis and having an emission area of 7 mm², the optical efficiency at the intersection plane for the narrow-beam configuration was approximately 67% and the optical efficiency at the far-field was approximately 65%. However, the shape of the illumination at the intersection plane and far-field were both square as illustrated in FIGS. 8C and 8D, respectively.

When the simulated system uses square light-emitting diodes, each with approximately 13° rotation about the optical axis to produce a non-rectangular array, having an emission area of 7 mm² the optical efficiency at the intersection plane for the narrow-beam configuration was approximately 67% and the optical efficiency at the far-field is approximately 65%. The shape of the illumination at the intersection plane and far-field had a somewhat circular shape as illustrated in FIGS. 8E and 8F, respectively.

Finally, a circular aperture was placed in a configuration having square dies without rotation. The aperture was located at the intersection plane, and was sized such that the diameter was as large as possible while still achieving circular illumination both at the intersection plane and at the far-field. The optical efficiency at the intersection plane for the narrow-beam configuration was approximately 42% and the optical efficiency at the far-field was approximately 40%. The shape of the illumination at the intersection plane and far-field approached a circular shape as illustrated in FIGS. 8G and 8H, respectively. Table 2 includes a summary of the data for the four configurations simulated in this example.

TABLE 2
Summary of simulation results from Example 2

| | | | Intersection | Intersection | | |
|---|---|---|---|---|---|---|
| | | | Plane | Plane | Far-field | Far-field |
| | | | Illumination | Optical | Illumination | Optical |
| LED | Aperture | Rotation | Shape | Efficiency | Shape | Efficiency |
| 7 mm², | No | n/a | Circular | 67% | Circular | 65% |
| Circular | | | | | | |
| 7 mm², | No | No | Square | 67% | Square | 65% |
| square | | | | | | |
| 7 mm², | No | Yes, 13° | Approximately | 67% | Approximately | 65% |
| square | | | Circular | | Circular | |
| 7 mm², | Yes | No | Circular | 42% | Approximately | 40% |
| square | | | | | Circular | |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

What is claimed is:

1. A system, comprising:
an array of light-emitting diodes having non-rectangular emission areas, the array of light-emitting diodes defining an outer perimeter having an approximately circular configuration; and
an array of collimating lenses,
wherein the collimating lenses are configured to receive light emitted from the light-emitting diodes and redirect at least a portion of the light received from the light-emitting diodes toward an intersection plane such that the re-directed light from each of the collimating lenses overlaps at the intersection plane.

2. A system, comprising:
an array of light-emitting diodes, comprising:
a first light-emitting diode having a non-rectangular emission area,
a second light-emitting diode having a non-rectangular emission area, and
a third light-emitting diode having a non-rectangular emission area; and
an array of collimating lenses comprising:
a first collimating lens configured to receive at least a portion of the light emitted by the first light-emitting diode,
a second collimating lens configured to receive at least a portion of the light emitted by the second light-emitting diode, and
a third collimating lens configured to receive at least a portion of the light emitted by the third light-emitting diode,
wherein the collimating lenses are configured to re-direct at least a portion of the light received from the light-emitting diodes toward an intersection plane such that the re-directed light from each of the collimating lenses overlaps at the intersection plane.

3. The system of claim 1, comprising a projection lens configured to receive light emitted by the light-emitting diodes.

4. The system of claim 3, wherein the intersection plane is positioned between the light-emitting diodes and the projection lens.

5. The system of claim 3, wherein the projection lens is positioned about one focal length away from the intersection plane.

6. The system of claim 3, wherein at least a portion of the re-directed light from the intersection plane passes through the projection lens.

7. The system of claim 1, comprising a focusing lens configured to receive light from the collimating lenses.

8. The system of claim 7, wherein the focusing lens is located between the collimating lenses and the intersection plane.

9. The system of claim 1, wherein at least one of the collimating lenses comprises an integrated wedge.

10. The system of claim 1, wherein optical axes of the light-emitting diodes are oriented such that they are at an angle relative to each other.

11. The system of claim 1, wherein optical axes of the collimating lenses are oriented such that they are at an angle relative to each other.

12. The system of claim 1, comprising an aperture located at or near the intersection plane.

13. The system of claim 12, wherein at least a portion of the re-directed light passes through the aperture.

14. The system of claim 1, wherein the collimating lenses are offset with respect to the light-emitting diodes.

15-16. (canceled)

17. The system of claim 1, wherein the non-rectangular emission area is substantially circular.

18-19. (canceled)

20. The system of claim 1, wherein the emission area has a surface area of at least about 1 mm².

21. The system of claim 1, wherein the re-directed light is in an image-space telecentric configuration at the intersection plane.

22. The system of claim 1, wherein the shape of the re-directed light is substantially circular at the intersection plane.

23-24. (canceled)

25. The system of claim 1, wherein the system is configured such that the light passes directly from the collimating lenses to the intersection plane without being redirected by a solid article.

26. A method of producing a substantially circular-shaped, far-field illumination, comprising:
emitting light from an array of light-emitting diodes comprising non-rectangular emission areas toward an array of collimating lenses, wherein:
at least a portion of the light emitted from the light-emitting diodes is re-directed by the collimating lenses toward an intersection plane, and
the re-directed light overlaps at the intersection plane.

27-35. (canceled)
